(19) United States
(12) Patent Application Publication
(10) Pub. No.: US 2025/0315026 A1
(43) Pub. Date: Oct. 9, 2025

(54) DIMENSION ESTIMATION DEVICE AND COMPUTER-READABLE STORAGE MEDIUM

(71) Applicant: FANUC CORPORATION, Yamanashi (JP)

(72) Inventor: Hiroaki HADA, Yamanashi (JP)

(21) Appl. No.: 18/701,930

(22) PCT Filed: Nov. 11, 2021
(86) PCT No.: PCT/JP2021/041601

§ 371 Date: Sep. 19, 2024

(51) Int. Cl. G05B 19/4097; G01B 21/02; G01B 21/10; G06T 11/20

(52) U.S. Cl. CPC G05B 19/4097; G01B 21/02; G01B 21/10; G06T 11/203; G05B 2219/35134

(57) ABSTRACT

This dimension estimation device comprises: a calculation unit for calculating, on the basis of a machining program, at least either one of a maximum value and a minimum value of a coordinate value indicating a position included in a cutting path; and an estimation unit for estimating the dimensions of a workpiece prior to machining, on the basis of the at least either one of the maximum value and the minimum value calculated by the calculation unit.

### TECHNICAL FIELD

The present disclosure relates to a dimension estimation device and a computer-readable storage medium.

### BACKGROUND ART

Conventionally, machining simulation has been performed before machining a workpiece (Patent Document 1). By performing machining simulation, an operator can verify whether or not a machining program normally operates.

### CITATION LIST

### Patent Document

Patent Document 1: JP H07-281724 A

### SUMMARY OF THE INVENTION

### Problem to be Solved by the Invention

However, when machining simulation is performed, the operator needs to check dimensions of the workpiece to be machined in advance using work instructions or the like, and then input the dimensions of the workpiece to a machining simulation device. Such work increases the burden on the operator.

An object of the disclosure is to provide a dimension estimation device capable of reducing the burden on the operator.

### Means for Solving Problem

A dimension estimation device includes a calculation unit configured to calculate at least one of a maximum value and a minimum value of coordinate values indicating positions included in a cutting path based on a machining program, and an estimation unit configured to estimate a dimension of a workpiece before machining based on at least one of the maximum value and the minimum value calculated by the calculation unit.

A computer-readable storage medium stores a command causing a computer to execute calculating at least one of a maximum value and a minimum value of coordinate values indicating positions included in a cutting path based on a machining program, and estimating a dimension of a workpiece before machining based on at least one of the calculated maximum value and minimum value.

### Effect of the Invention

According to one aspect of the disclosure, it is possible to improve work efficiency of the operator by presenting the dimensions of the workpiece before machining to the operator.

### BRIEF DESCRIPTION OF DRAWINGS

FIG. 1 is a block diagram illustrating an example of a hardware configuration of a machine tool;

FIG. 2 is a block diagram illustrating an example of functions of a dimension estimation device;

FIG. 3 is a diagram illustrating an example of a machining program;

FIG. 4 is a diagram illustrating an example of a cutting path;

FIG. 5 is a diagram illustrating an image of a workpiece;

FIG. 6 is a diagram illustrating an example of a flow of a dimension estimation process;

FIG. 7 is a diagram illustrating an example of a cutting path;

FIG. 8 is a diagram illustrating an image of the workpiece;

FIG. 9 is a diagram illustrating another example of the cutting path;

FIG. 10 is a diagram illustrating an image of the workpiece;

FIG. 11 is a block diagram illustrating an example of functions of the dimension estimation device including a reception unit;

FIG. 12 is a block diagram illustrating an example of functions of the dimension estimation device including a reflection unit;

FIG. 13A is a diagram illustrating an example of a machining program before dimensions of the workpiece are reflected;

FIG. 13B is a diagram illustrating an example of a machining program after the dimensions of the workpiece are reflected; and

FIG. 14 is a block diagram illustrating an example of functions of the dimension estimation device including a machining simulation unit.

### MODE(S) FOR CARRYING OUT THE INVENTION

Hereinafter, a machined surface estimation device according to embodiments of the disclosure will be described using the drawings. Note that not all combinations of features described in the embodiments below are necessarily necessary to solve the problem. Further, more detailed description than necessary may be omitted. Further, the following description of the embodiments and the drawings are provided to enable those skilled in the art to fully understand the disclosure, and are not intended to limit the scope of the claims.

A dimension estimation device is a device that performs dimension estimation process. The dimension estimation process is a process of estimating a dimension of a workpiece before machining based on a machining program. The dimension estimated in the dimension estimation process may be a dimension of a part of the workpiece. The dimension estimated in the dimension estimation process is, for example, a length of the workpiece in a Z-axis direction. The dimension estimated in the dimension estimation process may further include lengths of the workpiece in an X-axis direction and a Y-axis direction.

The dimension estimation device is mounted, for example, in a numerical controller that controls a machine tool. The dimension estimation device may be mounted in a server, or a PC (Personal Computer) connected by wire or wirelessly to the numerical controller. Hereinafter, a description will be given of an embodiment in which the dimension estimation device is mounted in the numerical controller.

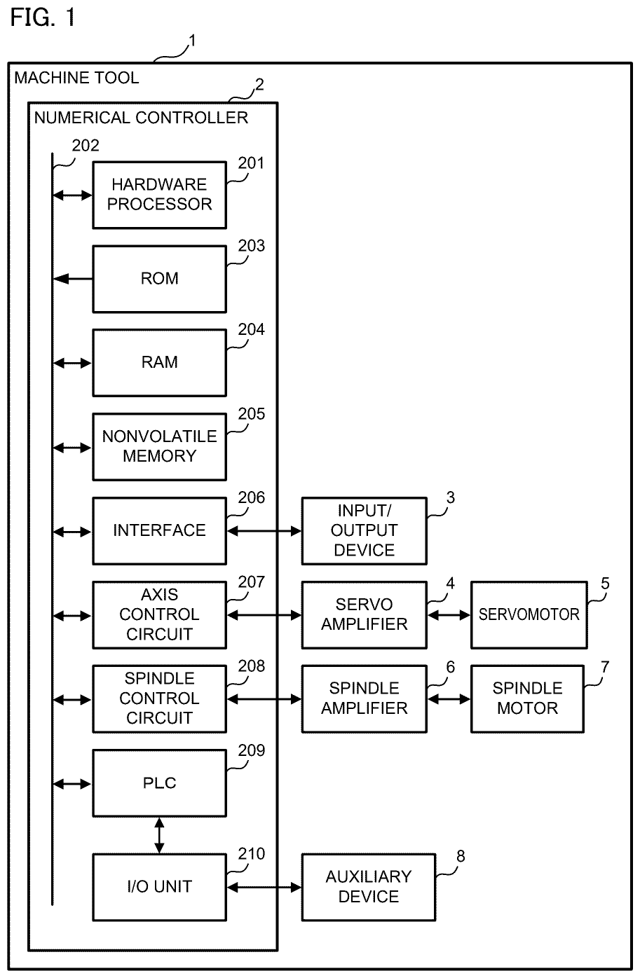

FIG. 1 is a block diagram illustrating an example of a hardware configuration of the machine tool including the numerical controller. The machine tool 1 is, for example, a lathe, a machining center, a drilling center, and a multi-tasking machine.

The machine tool 1 includes a numerical controller 2, an input/output device 3, a servo amplifier 4, a servomotor 5, a spindle amplifier 6, a spindle motor 7, and an auxiliary device 8.

The numerical controller 2 is a device that controls the entire machine tool 1. The numerical controller 2 includes a hardware processor 201, a bus 202, a ROM (Read Only Memory) 203, a RAM (Random Access Memory) 204, and a nonvolatile memory 205.

The hardware processor 201 is a processor that controls the entire numerical controller 2 according to a system program. The hardware processor 201 reads a system program or the like stored in the ROM 203 via the bus 202, and performs various processes based on the system program. The hardware processor 201 controls the servomotor 5 and the spindle motor 7 based on a machining program. Furthermore, the hardware processor 201 executes the dimension estimation process based on a dimension estimation program. The hardware processor 201 is, for example, a CPU (Central Processing Unit) or an electronic circuit.

For example, the hardware processor 201 analyzes a machining program and outputs control commands to the servomotor 5 and the spindle motor 7 every control cycle.

The bus 202 is a communication path that connects respective pieces of hardware inside the numerical controller 2 to each other. The respective pieces of hardware in the numerical controller 2 exchange data via the bus 202.

The ROM 203 is a storage device that stores system programs or the like for controlling the entire numerical controller 2. The ROM 203 may store the dimension estimation program. The ROM 203 is a computer-readable storage medium.

The RAM 204 is a storage device that temporarily stores various data. The RAM 204 functions as a work area for the hardware processor 201 to process various data.

The nonvolatile memory 205 is a storage device that retains data even when the machine tool 1 is powered off and no power is supplied to the numerical controller 2. The nonvolatile memory 205 stores, for example, a machining program and various parameters. The nonvolatile memory 205 is a computer-readable storage medium. The nonvolatile memory 205 is configured with, for example, a memory backed up by a battery or an SSD (Solid State Drive).

The numerical controller 2 further includes an interface 206, an axis control circuit 207, a spindle control circuit 208, a PLC (Programmable Logic Controller) 209, and an I/O unit 210.

The interface 206 connects the bus 202 and the input/output device 3 to each other. For example, the interface 206 sends various data processed by the hardware processor 201 to the input/output device 3.

The input/output device 3 is a device that receives various data via the interface 206 and displays the various data. Further, the input/output device 3 receives input of various data and sends the various data to, for example, the hardware processor 201 via the interface 206.

The input/output device 3 is, for example, a touch panel. When the input/output device 3 is a touch panel, the input/output device 3 is, for example, a capacitive-type touch panel. Note that the touch panel is not limited to a capacitive type, and may be a touch panel of another type. The input/output device 3 is installed on an operation panel (not illustrated) in which the numerical controller 2 is stored.

The axis control circuit 207 is a circuit that controls the servomotor 5. The axis control circuit 207 receives control commands from the hardware processor 201 and outputs various commands for driving the servomotor 5 to the servo amplifier 4. For example, the axis control circuit 207 sends a torque command to control the torque of the servomotor 5 to the servo amplifier 4.

The servo amplifier 4 receives a command from the axis control circuit 207, and supplies a current to the servomotor 5.

The servomotor 5 is driven by being supplied with a current from the servo amplifier 4. The servomotor 5 is connected to, for example, a ball screw that drives a tool post. By driving the servomotor 5, a structure of the machine tool 1, such as the tool post, moves in each axis direction. The servomotor 5 has a built-in encoder (not illustrated) that detects a position of a control axis and a feed rate. Position feedback information and speed feedback information indicating the position of the control axis and the feed rate of the control axis, respectively, detected by the encoder are fed back to the axis control circuit 207. In this way, the axis control circuit 207 performs feedback control of the control axis.

The spindle control circuit 208 is a circuit for controlling the spindle motor 7. The spindle control circuit 208 receives a control command from the hardware processor 201 and outputs a command for driving the spindle motor 7 to the spindle amplifier 6. The spindle control circuit 208 sends, for example, a spindle speed command that controls a rotational speed of the spindle motor 7 to the spindle amplifier 6.

The spindle amplifier 6 receives a command from the spindle control circuit 208 and supplies a current to the spindle motor 7.

The spindle motor 7 is driven by being supplied with a current from the spindle amplifier 6. The spindle motor 7 is connected to a main axis to rotate the main axis.

The PLC 209 is a device that executes a ladder program to control the auxiliary device 8. The PLC 209 sends a command to the auxiliary device 8 via the I/O unit 210.

The I/O unit 210 is an interface that connects the PLC 209 and the auxiliary device 8 to each other. The I/O unit 210 sends a command received from the PLC 209 to the auxiliary device 8.

The auxiliary device 8 is a device installed in the machine tool 1 to perform auxiliary operations in the machine tool 1. The auxiliary device 8 operates based on a command received from the I/O unit 210. The auxiliary device 8 may be a device installed around the machine tool 1. The auxiliary device 8 is, for example, a tool changer, a cutting fluid injection device, or an opening/closing door drive device.

Next, functions of the dimension estimation device will be described.

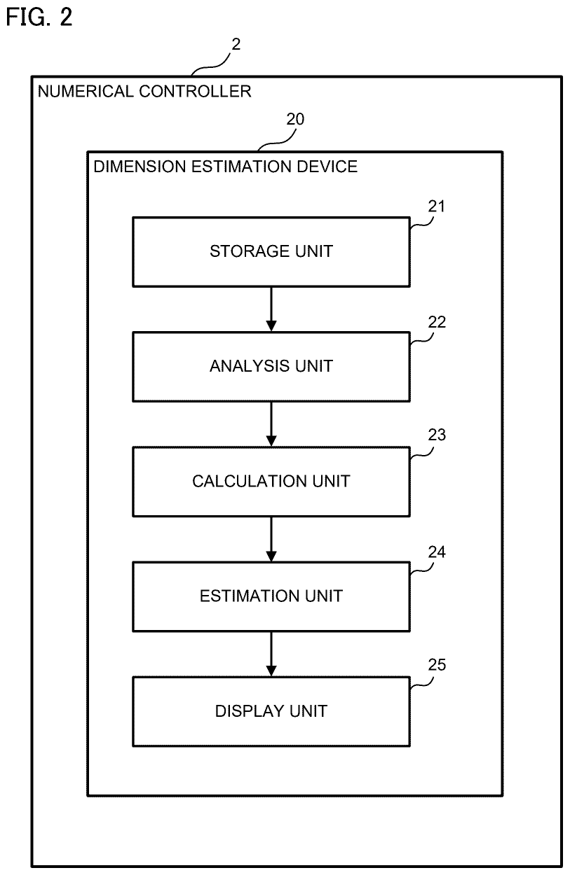

FIG. 2 is a block diagram illustrating an example of functions of the dimension estimation device mounted in the numerical controller 2. The dimension estimation device 20 includes a storage unit 21, an analysis unit 22, a calculation unit 23, an estimation unit 24, and a display unit 25. In the dimension estimation device 20, the dimension estimation process is executed by each of these units.

The storage unit 21 is realized, for example, by storing various data used in the dimension estimation process in the RAM 204 or the nonvolatile memory 205. The analysis unit 22, the calculation unit 23, the estimation unit 24, and the display unit 25 are realized, for example, by the hardware processor 201 performing arithmetic processing using a system program stored in the ROM 203, a dimension estimation program, and various data stored in the nonvolatile memory 205.

The storage unit 21 stores various data used in the dimension estimation process. The storage unit 21 stores, for example, a machining program and tool shape data.

The machining program is a program for machining a workpiece to be machined. In the machining program, commands for operating each axis of the machine tool are designated using, for example, G-code, F-code, M-code, T-code, and S-code.

The tool shape data includes data indicating a tool type, tool position correction data, tool diameter correction data, tool length correction data, and nose radius data. The tool shape data may be three-dimensional model data indicating a shape of the tool. The tool shape data is used, for example, for machining simulation.

The analysis unit 22 reads a machining program stored in the storage unit 21 and analyzes the machining program. The analysis unit 22 analyzes the meanings of commands such as G-code, F-code, M-code, T-code, and S-code designated in the machining program.

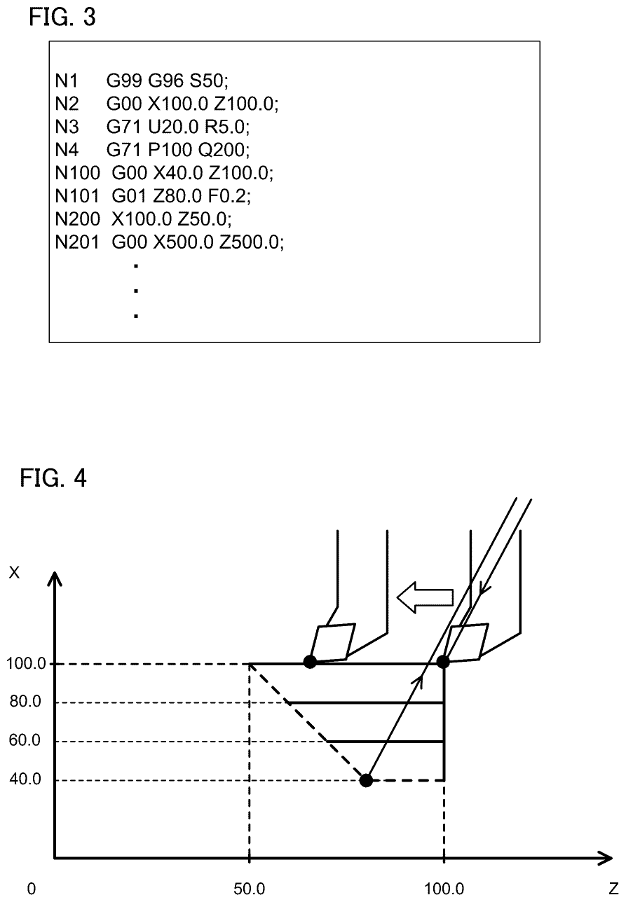

FIG. 3 is a diagram illustrating an example of machining program analyzed by the analysis unit 22. In a line of sequence number N1, “G99G96S50;” is written. “G99” is code that designates every rotational feed control. “G96” is code that designates constant circumferential speed control. “S50” is code that designates a circumferential speed.

In a line of sequence number N2, “G00X100.0Z100.0;” is written. “G00” is code that commands positioning. “X100.0” and “Z100.0” are, for example, coordinate values in a workpiece coordinate system. The coordinate values are coordinate values of a start point of a fixed cycle.

In a line of sequence number N3, “G71U20.0R5.0;” is written. “G71” is code that designates a fixed cycle for rough machining. “U” is code that designates a cutting depth. “R” is code that designates an escape amount.

In a line of sequence number N4, “G71P100Q200;” is written. “P” is code that designates a first sequence number in which a finished shape is defined in a fixed cycle. “Q” is code that designates a last sequence number in which the finished shape is defined. That is, the finished shape of the workpiece is designated in lines from sequence number N100 to sequence number N200.

In the line of sequence number N100, “G00X40.0Z100.0;” is written. In the line of sequence number N101, “G01Z80.OF0.2;” is written. Furthermore, in the line of sequence number N200, “X100. 0Z50. 0;” is written. In other words, in these lines, the finished shape of the workpiece is designated as a shape formed by sequentially connecting coordinates (40.0, 100.0), (40.0, 80.0), and (100.0, 50.0). “F” is code that designates the feed amount in every rotational feed control.

In a line of sequence number N201, “G00X500.0Z500.0;” is written. This command is a command that moves the tool to a tool exchange position.

The calculation unit 23 calculates at least one of a maximum value and a minimum value of coordinate values indicating positions included in a cutting path based on the machining program. The coordinate values of the positions included in the cutting path may include a first coordinate value indicating a position in a first axial direction and a second coordinate value indicating a position in a second axial direction. For example, the coordinate values indicating the cutting path include a coordinate value indicating a position in the X-axis direction and a coordinate value indicating a position in the Z-axis direction. Therefore, the calculation unit 23 calculates at least one of a maximum value and a minimum value of coordinate values in the X-axis direction and at least one of a maximum value and a minimum value of coordinate values in the Z-axis direction among the coordinate values of the positions included in the cutting path.

Further, the calculation unit 23 draws a cutting path in a virtual plane or a virtual space based on the machining program, and calculates at least one of a maximum value and a minimum value of coordinate values indicating the cutting path based on the cutting path drawn in the virtual plane or the virtual space. Here, the cutting path is a path along which the tool moves by cutting feed. Therefore, the cutting path does not include a path along which the tool moves by rapid traverse according to the positioning command “G00”.

FIG. 4 is a diagram illustrating an example of a cutting path drawn by the calculation unit 23. FIG. 4 illustrates a cutting path drawn by the calculation unit 23 based on the machining program illustrated in FIG. 3.

The calculation unit 23 positions the tool at a position of X100.0 and Z100.0 based on the positioning command written in the line of sequence number N2. Further, the calculation unit 23 draws a cutting path in the virtual plane based on the commands designating the fixed cycle for rough machining written in the lines of sequence numbers N3 to N200.

Specifically, the calculation unit 23 draws a rapid traverse path that moves the tool from the position of X100.0 and Z100.0 to a position of X80.0 and Z100.0 by rapid traverse. The calculation unit 23 draws the rapid traverse path using, for example, a solid line.

Next, the calculation unit 23 draws a cutting path that moves the tool from the position of X80.0 and Z100.0 to a position of X80.0 and Z60.0 by cutting feed. The calculation unit 23 draws the cutting path using, for example, a dotted line.

Next, the calculation unit 23 draws a cutting path that moves the tool from the position of X80.0 and Z60.0 to a position of X100.0 and Z50.0 by cutting feed. Next, the calculation unit 23 draws a rapid traverse path from the position of X100.0 and Z50.0 to the position of X100.0 and Z100.0.

Next, the calculation unit 23 draws a rapid traverse path from the position of X100.0 and Z100.0 to a position of X60.0 and Z100.0. Next, the calculation unit 23 draws a cutting path from the position of X60.0 and Z100.0 to a position of X60.0 and Z70.0. Next, the calculation unit 23 draws a cutting path from the position of X60.0 and Z70.0 to the position of X80.0 and Z60.0. Next, the calculation unit 23 draws a rapid traverse path from the position of X80.0 and Z60.0 to the position of X80.0 and Z100.0.

Next, the calculation unit 23 draws a rapid traverse path from the position of X80.0 and Z100.0 to a position of X40.0 and Z100.0. Next, the calculation unit 23 draws a cutting path from the position of x40.0 and Z100.0 to a position of X40.0 and Z80.0. Next, the calculation unit 23 draws a cutting path from the position of X40.0 and Z80.0 to the position of X60.0 and Z70.0. Next, the calculation unit 23 draws a rapid traverse path from the position of X60.0 and Z70.0 to the position of X60.0 and Z100.0.

Next, the calculation unit 23 draws a rapid traverse path from the position of X60.0 and Z100.0 to the position of X100.0 and Z100.0. Finally, the calculation unit 23 draws a rapid traverse path from the position of X100.0 and Z100.0 to a position of X500.0 and Z500.0. Here, even though the calculation unit 23 does not draw a path related to escape movement of the tool, the calculation unit 23 may draw a path related to escape movement.

Among the coordinate values indicating the positions included in the cutting path drawn by the calculation unit 23, the maximum value of the coordinate values in the X-axis direction is 100.0, and the maximum value of the coordinate values in the Z-axis direction is 100.0. Therefore, the calculation unit 23 calculates both the maximum value of the coordinate values in the X-axis direction and the maximum value of the coordinate values in the Z-axis direction to be 100.0 among the coordinate values indicating the positions included in the cutting path.

The estimation unit 24 estimates the dimension of the workpiece before machining based on at least one of the maximum value and the minimum value of the coordinate values indicating the cutting path calculated by the calculation unit 23. In other words, the estimation unit 24 may estimate the dimension of the workpiece before machining based on the maximum value without using the minimum value. For example, when one end of the workpiece is set at a position of 0.0 in the Z-axis direction, the estimation unit 24 estimates a length of the workpiece based on the maximum value without using the minimum value of the coordinate values in the Z-axis direction.

For example, when a turning program is executed, if the maximum value of the coordinate values in the X-axis direction and the maximum value of the coordinate values in the Z-axis direction calculated by the calculation unit 23 are both 100.0, the estimation unit 24 may estimate the dimensions of the workpiece before machining to be 100.0 [mm] in diameter and 100.0 [mm] in length. In this case, the estimation unit 24 estimates the length of the workpiece on the assumption that one end of the workpiece is at a position of Z0.0. Note that, when the workpiece is turned over the entire length, the estimation unit 24 may estimate the length of the workpiece based on a difference between the maximum value and the minimum value in the Z-axis direction.

The dimension estimation device 20 may be able to set that one end or one surface of the workpiece is at a position of 0.0 in any one of the X-axis direction, the Y-axis direction, and the Z-axis direction as a predetermined parameter. In this way, the estimation unit 24 can determine whether to estimate the dimensions of the workpiece based on the maximum value and the minimum value of the coordinate values indicating the cutting path or whether to estimate the dimensions of the workpiece based only on the maximum value.

The display unit 25 displays the dimensions of the workpiece estimated by the estimation unit 24. For example, the display unit 25 displays the dimensions of the workpiece on a display screen of the input/output device 3.

For example, when the estimation unit 24 estimates that a diameter dimension is 100.0 [mm] and an axial length is 100.0 [mm], the display unit 25 displays information indicating that dimensions of the workpiece before machining are 100.0 [mm] in diameter and 100.0 [mm] in length on a display screen.

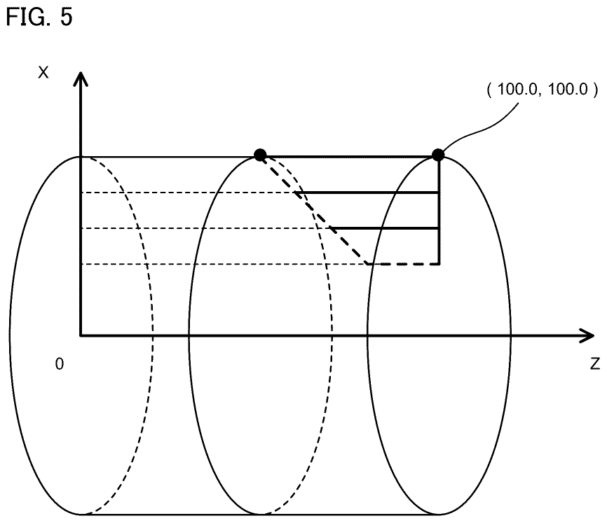

FIG. 5 is a diagram illustrating an image of the workpiece configured with dimensions estimated by the estimation unit 24. The display unit 25 displays, for example, an image of a columnar workpiece having a diameter of 100.0 [mm] and a length of 100.0 [mm] on the display screen. The display unit 25 may display numerical values indicating the diameter and the length of the workpiece on the display screen instead of the image of the workpiece.

Note that, without drawing the cutting path, the calculation unit 23 may directly calculate at least one of the maximum value and the minimum value of the coordinate values indicating the positions included in the cutting path from coordinate values included in a cutting command designated in the machining program. The cutting command is, for example, a linear interpolation command G01 and circular interpolation commands G02 and G03.

In the machining program illustrated in FIG. 3, X100.0 is the maximum value of the coordinate values in the X-axis direction included in the cutting command, and Z100.0 is the maximum value of the coordinate values in the Z-axis direction. Therefore, the calculation unit 23 calculates both the maximum value of the coordinate values in the X-axis direction and the maximum value of the coordinate values in the Z-axis direction as 100.0, based on the machining program.

The estimation unit 24 estimates the dimensions of the workpiece before machining based on at least one of the maximum value and the minimum value of the coordinate values indicating the cutting path calculated by the calculation unit 23.

For example, when the maximum value of the coordinate values in the X-axis direction and the maximum value of the coordinate values in the Z-axis direction calculated by the calculation unit 23 based on the turning program are both 100.0, the estimation unit 24 estimates the dimensions of the workpiece before machining to be 100.0 [mm] in diameter and 100.0 [mm] in length.

The display unit 25 displays the dimensions of the workpiece estimated by the estimation unit 24. For example, the display unit 25 displays the dimensions of the workpiece on the display screen of the input/output device 3.

When the estimation unit 24 estimates that the diameter is 100.0 [mm] and the length is 100.0 [mm], the display unit 25 displays information indicating that a diameter of the workpiece before machining is 100.0 [mm] and a length thereof is 100.0 [mm] on the display screen.

Next, a description will be given of a flow of a dimension estimation process executed by the dimension estimation device 20.

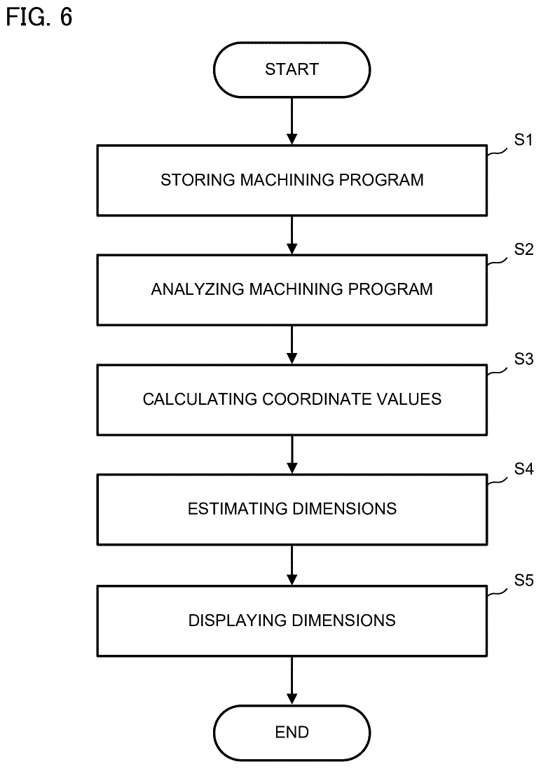

FIG. 6 is a diagram illustrating an example of a flow of the dimension estimation process. In the dimension estimation process, first, the storage unit 21 stores a machining program (step S1). The storage unit 21 stores, for example, a machining program received from an external device such as a server.

Next, the analysis unit 22 reads the machining program from the storage unit 21 and analyzes the machining program (step S2).

Next, the calculation unit 23 calculates at least one of a maximum value and a minimum value of coordinate values indicating positions included in a cutting path based on the machining program (step S3).

Next, the estimation unit 24 estimates dimensions of a workpiece before machining based on at least one of the maximum value and minimum value of the coordinate values indicating the positions included in the cutting path calculated by the calculation unit 23 (step S4).

Next, the display unit 25 displays the dimensions of the workpiece before machining estimated by the estimation unit 24 (step S5), and the process ends.

As described above, the dimension estimation device 20 includes the calculation unit 23 that calculates at least one of the maximum value and minimum value of the coordinate values indicating the positions included in the cutting path based on the machining program, and the estimation unit 24 that estimates the dimensions of the workpiece before machining based on at least one of the maximum value and the minimum value calculated by the calculation unit 23. Furthermore, the device further includes the display unit 25 that displays the dimensions of the workpiece estimated by the estimation unit 24. Therefore, the dimension estimation device 20 can present the dimensions of the workpiece before machining to an operator.

As a result, when the operator performs setup work before machining, the operator can perceive the dimensions of the workpiece to be installed in the machine tool 1 without checking work instructions.

Further, the calculation unit 23 draws a cutting path in the virtual plane or the virtual space, and calculates at least one of the maximum value and the minimum value of the coordinate values based on the cutting path drawn in the virtual plane or the virtual space. Therefore, even when the cutting path is designated using an incremental command in the machining program, the dimension estimation device 20 can estimate the dimensions of the workpiece before machining. Note that the incremental command is a command that designates the amount of movement from coordinate values of a current position to coordinate values of a destination.

Further, the coordinate values indicating the positions included in the cutting path include the first coordinate value indicating a position in the first axis direction and the second coordinate value indicating a position in the second axis direction. Therefore, it is possible to estimate two axial dimensions of the workpiece before machining.

In the embodiments described above, the coordinate values indicating the positions included in the cutting path include the first coordinate value indicating the position in the first axis direction and the second coordinate value indicating the position in the second axis direction. However, the coordinate values do not necessarily have to include the first coordinate value and the second coordinate value. For example, when drilling is performed at a drilling center and a coordinate value of a bottom surface of the workpiece in the Z-axis direction is set to “0”, the calculation unit 23 may calculate a position of a cutting start point, that is, only a maximum value of the coordinate values in the Z-axis direction. In this way, the dimension estimation device 20 can estimate a thickness of the workpiece before machining.

In the embodiments described above, an example has been described in which the dimension estimation device 20 estimates the dimensions of the workpiece before machining based on the turning program. However, the machining program may also be a milling program.

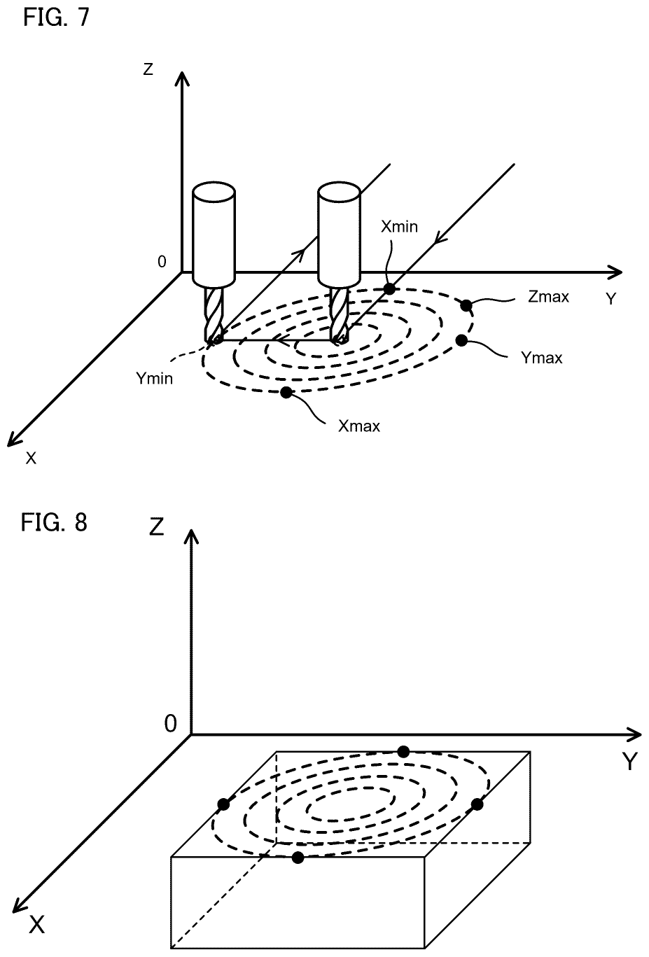

FIG. 7 is a diagram illustrating an example of a cutting path drawn by the calculation unit 23 based on the milling program. A shape of the cutting path illustrated in FIG. 7 is circles of different sizes centered on a predetermined axis parallel to a Z-axis at a predetermined position in the Z-axis direction. The calculation unit 23 calculates a maximum value Xmax and a minimum value Xmin of coordinate values in the X-axis direction, a maximum value Ymax and a minimum value Ymin in the Y-axis direction, and a maximum value Zmax in the Z-axis direction.

The estimation unit 24 estimates dimensions of the workpiece before machining based on the maximum value Xmax and the minimum value Xmin of the coordinate values in the X-axis direction, the maximum value Ymax and the minimum value Ymin of the coordinate values in the Y-axis direction, and the maximum value Zmax of the coordinates value in the Z-axis direction calculated by the calculation unit 23. Specifically, the estimation unit 24 calculates (Xmax-Xmin) as a dimension in the X-axis direction, (Ymax-Ymin) as a dimension in the Y-axis direction, and Zmax as a dimension in the Z-axis direction.

FIG. 8 is a diagram illustrating an image of the workpiece configured with the dimensions estimated by the estimation unit 24. For example, the estimation unit 24 estimates, as the workpiece, a rectangular parallelepiped whose length in a depth direction is (Xmax-Xmin), width is (Ymax-Ymin), and height is Zmax.

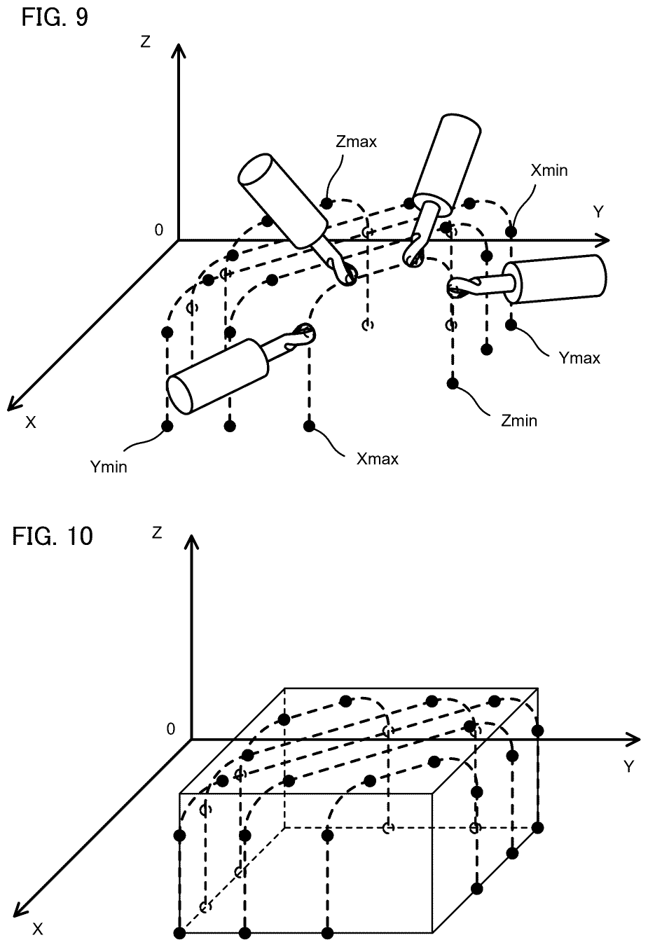

FIG. 9 is a diagram illustrating another example of the cutting path drawn by the calculation unit 23 based on the milling program. The cutting path illustrated in FIG. 9 includes a path extending in the Z-axis direction, a path extending in a plane parallel to an XY plane, and a path connecting these two paths using an arc. In this case, the calculation unit 23 calculates a maximum value Xmax and a minimum value Xmin of coordinate values in the X-axis direction, a maximum value Ymax and a minimum value Ymin in the Y-axis direction, and a maximum value Zmax and a minimum value Zmin in the Z-axis direction.

The estimation unit 24 estimates dimensions of the workpiece before machining based on (Xmax-Xmin), (Ymax-Ymin), and (Zmax-Zmin).

FIG. 10 is a diagram illustrating an image of the workpiece configured with the dimensions estimated by the estimation unit 24. The estimation unit 24 estimates, as the workpiece, a rectangular parallelepiped whose length in the depth direction is (Xmax-Xmin), width is (Ymax-Ymin), and height is (Zmax-Zmin).

In the embodiments described above, when the machining program is the turning program, the estimation unit 24 estimates that the shape of the workpiece before machining is a columnar shape. Furthermore, when the machining program is the milling program, the estimation unit 24 estimates that the shape of the workpiece before machining is a rectangular parallelepiped. However, the dimension estimation device 20 may further include a reception unit that receives shape information indicating the shape of the workpiece.

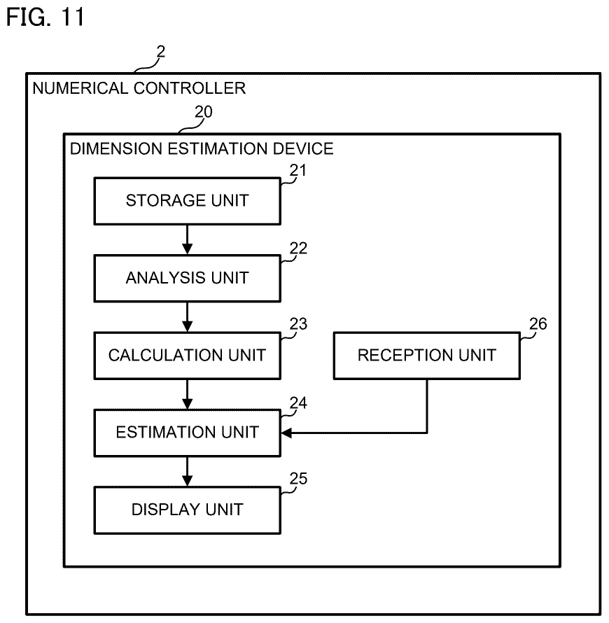

FIG. 11 is a block diagram illustrating an example of functions of the dimension estimation device 20 including a reception unit. Here, functions different from those of the dimension estimation device 20 described using FIG. 2 will be described, and descriptions of the same functions as those of the dimension estimation device 20 of FIG. 2 will be omitted.

The reception unit 26 receives shape information indicating the shape of the workpiece. The shape information is information indicating, for example, a columnar shape, a cylindrical shape, a rectangular parallelepiped shape, a cubic shape, or a conical shape.

For example, the reception unit 26 may display a pull-down menu on the display screen of the input/output device 3 so that one piece of shape information is be selected from a plurality of types of shapes. The reception unit 26 receives the selected shape information.

The estimation unit 24 estimates the dimensions and shape of the workpiece before machining based on the shape information received by the reception unit 26. Furthermore, the display unit 25 displays the workpiece before machining based on the shape information received by the reception unit 26.

The dimension estimation device 20 may further include a reflection unit that reflects the dimensions of the workpiece before machining estimated by the estimation unit 24 on the machining program.

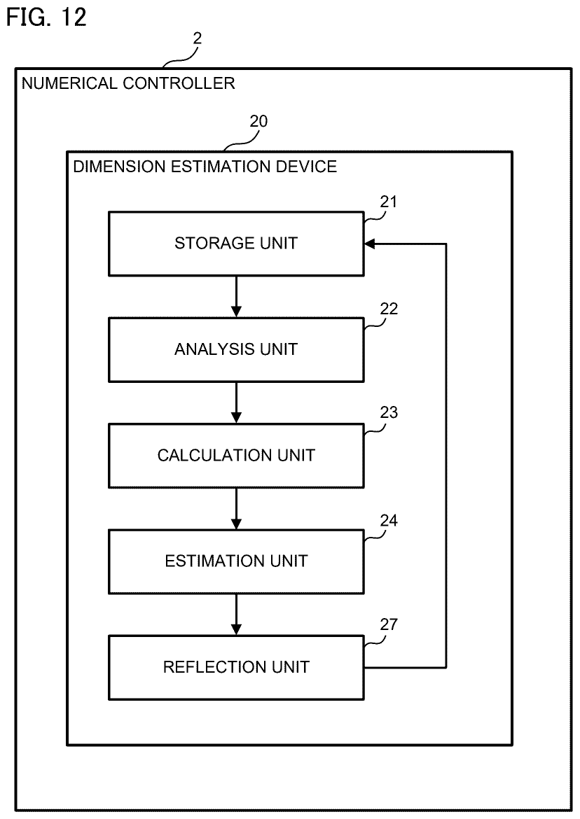

FIG. 12 is a block diagram illustrating an example of functions of the dimension estimation device 20 including a reflection unit. Here, functions different from those of the dimension estimation device 20 described using FIG. 2 will be described, and descriptions of the same functions as those of the dimension estimation device 20 of FIG. 2 will be omitted.

The reflection unit 27 reflects the dimensions of the workpiece before machining estimated by the estimation unit 24 in the machining program. In other words, the reflection unit 27 writes information indicating the dimensions of the workpiece before machining estimated by the estimation unit 24 to the machining program stored in the storage unit 21.

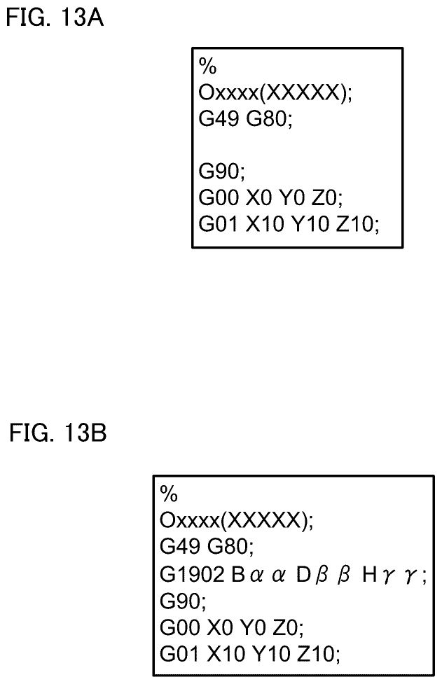

FIG. 13A is a diagram illustrating an example of a machining program before dimensions of the workpiece are reflected. FIG. 13B is a diagram illustrating an example of a machining program after the dimensions of the workpiece are reflected. The reflection unit 27 writes a command “G19aaBxxDyyHzz;” between a line where G49 and G80 designated by the machining program are written and a line where G90 is written. Here, “αα” is a numerical value designating the shape of the workpiece. For example, when “αα” is “02”, the workpiece shape is a rectangular parallelepiped. Further, “xx” indicates, for example, the dimension of the workpiece in the X-axis direction, “yy” indicates the dimension of the workpiece in the Y-axis direction, and “zz” indicates the dimension of the workpiece in the Z-axis direction.

The dimension estimation device 20 may further include a machining simulation unit that performs machining simulation based on the dimensions of the workpiece before machining estimated by the estimation unit 24.

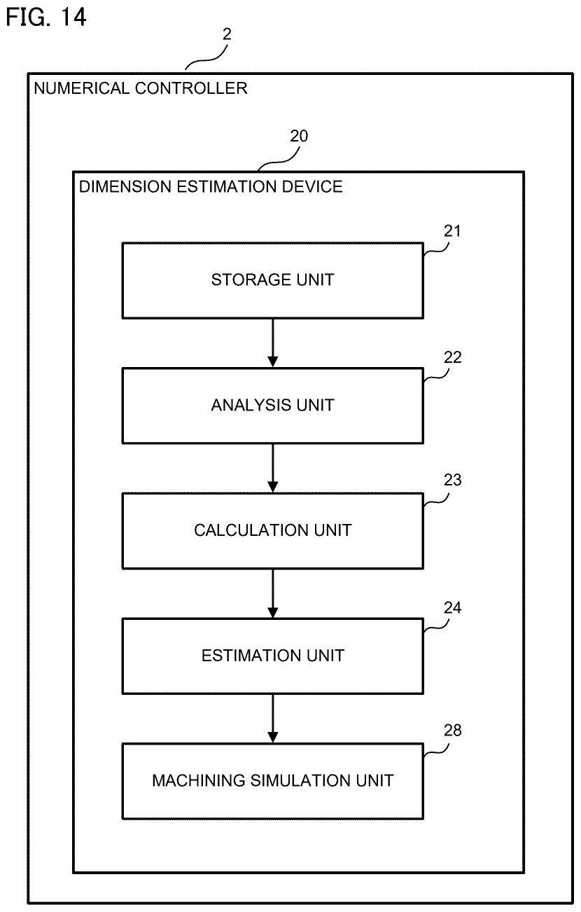

FIG. 14 is a block diagram illustrating an example of functions of the dimension estimation device 20 including the machining simulation unit. Here, functions different from those of the respective units of the dimension estimation device 20 described using FIG. 2 will be described.

The machining simulation unit 28 executes machining simulation based on the dimensions of the workpiece before machining estimated by estimation unit 24. The machining simulation unit 28 displays an image of the workpiece before machining based on the dimensions of the workpiece before machining estimated by the estimation unit 24. Furthermore, the machining simulation unit 28 executes machining simulation of the workpiece based on the machining program stored in the storage unit 21.

The machining simulation unit 28 may execute machining simulation using the shape information indicating the shape of the workpiece received by the reception unit 26. Further, the machining simulation unit 28 may execute machining simulation based on a machining program in which the dimensions of the workpiece before machining are written by the reflection unit 27.

In the embodiments described above, the estimation unit 24 estimates the dimensions of the workpiece before machining based on at least one of the maximum value and the minimum value calculated by the calculation unit 23. However, the estimation unit 24 may further estimate the dimensions of the workpiece before machining based on the cutting depth.

For example, when an upper surface of a rectangular parallelepiped workpiece is cut using a milling cutter, the milling cutter is positioned, for example, at a position where cutting is performed by a predetermined cutting depth from the upper surface of the workpiece before machining, and cutting is started. In this case, when the estimation unit 24 estimates dimensions of the workpiece before machining based on a maximum value and a minimum value of coordinate values indicating positions included in a cutting path, there is concern that the estimated dimensions may become smaller than actual dimensions of the workpiece before machining.

Therefore, the estimation unit 24 estimates a value obtained by adding the cutting depth to the dimension estimated based on the maximum value and the minimum value of the coordinate values as the actual dimension of the workpiece before machining. In this way, the dimensions of the workpiece before machining can be estimated with high accuracy.

Note that the disclosure is not limited to the above embodiments, and can be modified as appropriate without departing from the spirit. In the disclosure, it is possible to modify any component of the embodiments or omit any component of the embodiments.

### EXPLANATIONS OF LETTERS OR NUMERALS

1 MACHINE TOOL
2 NUMERICAL CONTROLLER
20 DIMENSION ESTIMATION DEVICE
21 STORAGE UNIT
22 ANALYSIS UNIT
23 CALCULATION UNIT
24 ESTIMATION UNIT
25 DISPLAY UNIT
26 RECEPTION UNIT
27 REFLECTION UNIT
28 MACHINING SIMULATION UNIT
201 HARDWARE PROCESSOR
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
3 INPUT/OUTPUT DEVICE
4 SERVO AMPLIFIER
5 SERVOMOTOR
6 SPINDLE AMPLIFIER
7 SPINDLE MOTOR
8 AUXILIARY DEVICE

1. A dimension estimation device comprising:
a calculation unit configured to calculate at least one of a maximum value and a minimum value of coordinate values indicating positions included in a cutting path based on a machining program; and
an estimation unit configured to estimate a dimension of a workpiece before machining based on at least one of the maximum value and the minimum value calculated by the calculation unit.

2. The dimension estimation device according to claim 1, wherein the calculation unit draws the cutting path in a virtual plane or a virtual space, and calculates at least one of the maximum value and the minimum value of the coordinate values based on the cutting path drawn in the virtual plane or the virtual space.

3. The dimension estimation device according to claim 1 or 2, wherein the coordinate values include a first coordinate value indicating a position in a first axial direction and a second coordinate value indicating a position in a second axial direction.

4. The dimension estimation device according to any one of claims 1 to 3, further comprising a display unit configured to display the dimension of the workpiece before machining estimated by the estimation unit.

5. The dimension estimation device according to any one of claims 1 to 4, further comprising a reception unit configured to receive shape information indicating a shape of the workpiece.

6. The dimension estimation device according to any one of claims 1 to 5, further comprising a reflection unit configured to reflect the dimension of the workpiece before machining estimated by the estimation unit on the machining program.

7. The dimension estimation device according to any one of claims 1 to 6, further comprising a machining simulation unit configured to execute machining simulation based on the dimension of the workpiece before machining estimated by the estimation unit.

8. The dimension estimation device according to any one of claims 1 to 7, wherein the estimation unit further estimates the dimension of the workpiece before machining based on a cutting depth.

9. A computer-readable storage medium storing a command causing a computer to execute:
calculating at least one of a maximum value and a minimum value of coordinate values indicating positions included in a cutting path based on a machining program; and
estimating a dimension of a workpiece before machining based on at least one of the maximum value and the minimum value which is calculated.
